(19) United States
(12) Patent Application Publication
(10) Pub. No.: US 2015/0106334 A1
(43) Pub. Date: Apr. 16, 2015

(54) SYSTEMS AND METHODS FOR BACKING UP A LIVE VIRTUAL MACHINE

(71) Applicant: PHD VIRTUAL TECHNOLOGIES, Philadelphia, PA (US)

(72) Inventor: Cy S. Lee, Basking Ridge, NJ (US)

(21) Appl. No.: 14/268,067

(22) Filed: May 2, 2014

Related U.S. Application Data
(60) Provisional application No. 61/891,401, filed on Oct. 15, 2013.

(51) Int. Cl. G06F 17/30; G06F 9/455

(52) U.S. Cl. CPC G06F 17/30088; G06F 9/45558; G06F 2009/45562
USPC 707/639

(57) ABSTRACT

In many circumstances, it is advantageous to backup the data for a VM while it is in operation. Traditionally, this is accomplished by taking a snapshot of the VM while it is running. After a snapshot has been created, the preserved data is typically referred to as the base disk. The base disk can then be used to create a consistent backup. The hypervisor on which a VM is running can sometimes be used to create a snapshot, but not all virtualization platforms allow access to the base disk after the hypervisor has created the snapshot. The present disclosure features a method for creating a backup for a virtual machine while it is operating through the use of a snapshot and a differencing disk.

### CROSS REFERENCE TO RELATED APPLICATIONS

The present disclosure claims the benefit of and priority to U.S. Provisional Application Ser. No. 61/891,401, filed on Oct. 15, 2013, entitled “SYSTEMS AND METHODS FOR BACKING UP A LIVE VIRTUAL MACHINE”, the entirety of which is incorporated by reference herein for all purposes.

### BACKGROUND

1. Technical Field

The present disclosure relates to creating a backup for a virtual machine while it is in operation, and more particularly, to a method wherein a snapshot is created and access to the base disk is obtained through the use of a differencing disk.

2. Description of Related Art

A hypervisor is a software abstraction of an underlying physical machine (“host”) which enables one or more instances of an operating system, or one or more operating systems, to run concurrently on a physical host machine. A virtual machine (VM) is an instance of an operating system that uses a set of files which represent the virtual machine's configuration settings and the file system of the virtual machine, and typically contain the virtual machine's operating system, applications, data files, etc. In VMware's vSphere, some of these files include the virtual machine configuration file (e.g., vmname.vmx), the virtual disk characteristics file (e.g., vmname.vmdk), and the virtual machine data disk file (e.g., vmname-flat.vmdk). In Microsoft's Hyper-V, which is another popular virtualization platform, some of these files include the virtual machine configuration file (e.g., vmInstanceID.xml) and the virtual hard disk file (e.g., diskName.vhd and diskName.vhdx).

In many circumstances, it is advantageous to backup the data for a VM while it is in operation. Traditionally, this is accomplished by taking a snapshot of the VM while it is running. A snapshot is a file, or a set of files, that preserves the state of a system at a particular point in time by intercepting read/write requests to the corresponding set of data. Two commonly used techniques for implementing a snapshot are redirect-on-write and copy-on-write. Some virtualization platforms, such as Hyper-V Server 2012 R2, refer to snapshots as checkpoints.

After a snapshot has been created, the preserved data is typically referred to as the base disk. The base disk can then be used to create a consistent backup. The hypervisor on which a VM is running can sometimes be used to create a snapshot, but not all virtualization platforms allow access to the base disk after the hypervisor has created the snapshot (e.g., Hyper-V). One workaround used in the industry when the hypervisor cannot be used to create a snapshot with an accessible base disk is to create and mount a snapshot using the built-in functionality of a storage array. This workaround is inefficient when a few selected VMs need to be backed up because a snapshot taken by a storage array is of an entire logical unit or volume, which may contain the virtual disk files for numerous VMs.

### SUMMARY

The present disclosure features a method for creating a backup for a virtual machine while it is operating through the use of a snapshot and a differencing disk. As used herein, a differencing disk is defined as a file representing the current state of the virtual disk as a set of modified blocks in comparison to a parent or base virtual disk. Differencing disks can be associated with either a fixed virtual disk or a dynamic virtual disk. A fixed virtual disk is a file that is the same size as the size specified for the virtual disk. A dynamic virtual disk is a file that, at any given time, is as large as the actual data written to it plus the size of on-disk metadata. The differencing disk starts with no data and grows over time to store the unique differencing data. A differencing disk is not the same as a snapshot in Hyper-V. Hyper-V does not support the same functionality or visibility for differencing disks and snapshots.

In one aspect, the present disclosure features a system including a backup data storage area, a production data storage area storing at least one virtual disk file, a backup appliance that manages the creation of backup files in the backup data storage area for the at least one virtual disk file, and a host computer running a hypervisor, wherein the hypervisor manages a root partition and at least one virtual machine. The at least one virtual machine is associated with the at least one virtual disk file. The root partition has a set of instructions executable on a processor for interpreting backup commands sent from the backup appliance and causing the host computer to: take a snapshot of the at least one virtual disk file to obtain a snapshot file and a base disk file; create a differencing disk file from the base disk file; and create a backup file by reading the content presented by the differencing disk file and storing data that correlates to the content of the base disk file.

In another aspect, the present disclosure features a method including taking a snapshot of a virtual disk file of the virtual machine to obtain a snapshot file and a base disk file; creating a differencing disk file from the base disk file; creating a backup file by reading the content presented by the differencing disk file and storing data that correlates to the content of the base disk file; deleting the differencing disk file; and saving changes made to the virtual machine during performance of the preceding steps by merging the changes captured in the snapshot file with the base disk file and deleting the snapshot file.

### BRIEF DESCRIPTION OF THE DRAWINGS

Various embodiments of the present disclosure will be described below with reference to the figures, wherein:

FIG. 1 is a block diagram of a generic system virtual machine;

FIG. 2 is a block diagram of a backup system in accordance with embodiments of the present disclosure;

FIG. 3 is a block diagram of a backup system used during the backup procedure in accordance with embodiments of the present disclosure; and

FIG. 4 is a flow chart illustrating a method for backing up a live virtual machine in accordance with an embodiment of the present disclosure.

### DETAILED DESCRIPTION

Embodiments of the present disclosure are described in detail with reference to the drawing figures wherein like reference numerals identify similar or identical elements. It is to be understood that the disclosed embodiments are merely examples of the disclosure, which may be embodied in various forms. Well-known functions or constructions are not described in detail to avoid obscuring the present disclosure in unnecessary detail. Therefore, specific structural and functional details disclosed herein are not to be interpreted as limiting, but merely as a basis for the claims and as a representative basis for teaching one skilled in the art to variously employ the present disclosure in virtually any appropriately detailed structure.

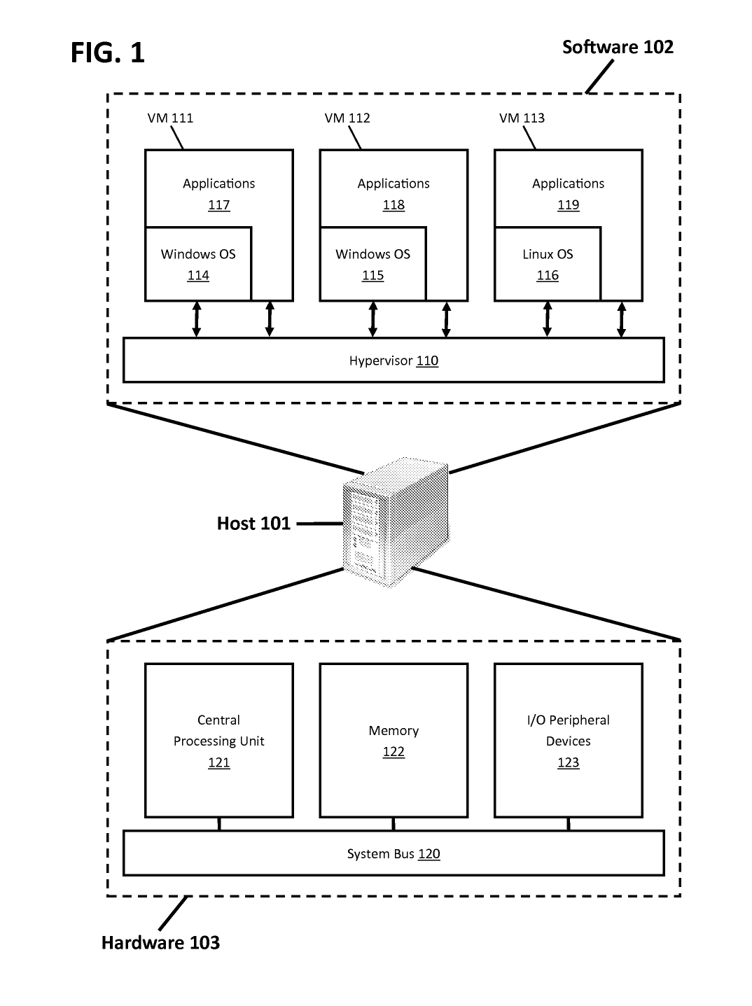

FIG. 1 is a block diagram of a generic system virtual machine. There are two types of virtual machines: process virtual machines and system virtual machines. A system virtual machine provides an environment where several different operating systems or guests can coexist on the same hardware platform or host. The hypervisor, which is sometimes referred to as the virtual machine monitor (VMM), sits between the various guest systems and the hardware. More specifically, the hypervisor intercepts and implements all instructions sent from the guest systems that directly involve the shared hardware. In other words, the hypervisor emulates the Instruction Set Architecture (ISA). In some system virtual machines, the hypervisor is used as a translation layer when the guest system and the host use different ISAs.

In FIG. 1, VMs 111, 112, and 113 are guest systems that interface with hardware 103 of host 101 through hypervisor 110. VMs 111 and 112 are running Windows operating systems 114 and 115 respectively. VM 113 is running Linux operating system 116. VMs 111, 112, and 113 are also running applications 117, 118, and 119 respectively. Collectively, hypervisor 110 and VMs 111, 112, and 113 can be referred to as software 102. Typical examples of the types of hardware found in host 101 include central processing unit 121, memory 122, I/O peripheral devices 123, and system bus 120. Examples of I/O peripheral devices include external hard drives, network interface controllers, and USB controllers.

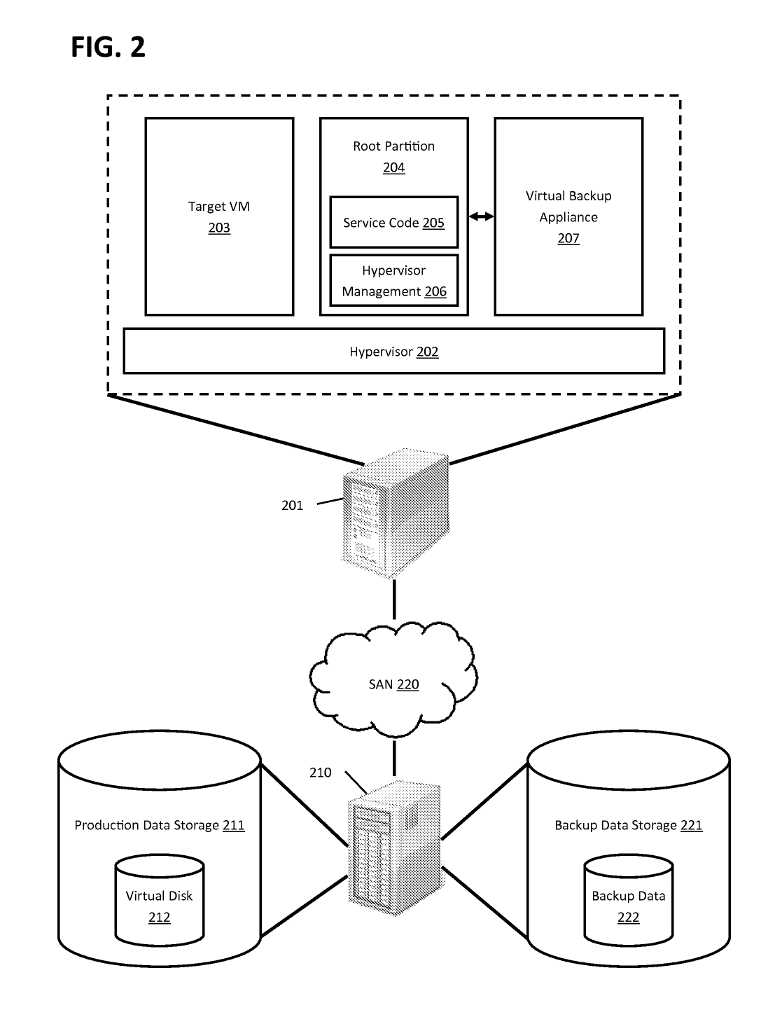

FIG. 2 is a block diagram of a backup system. Host computer 201 has virtualization software installed and has target VM 203, root partition 204, and virtual backup appliance 207 running on it. Virtual backup appliance 207 is responsible for periodically creating a backup for virtual disk 212 in production data storage 211, which is associated with target VM 203. The resulting backup is represented as backup data 222 in backup data storage 221. Both production data storage 211 and backup data storage 221 are located in storage array 210. It should be understood that this is a non-limiting example and, in an actual system, virtual backup appliance 207 would be responsible for backing up numerous VMs. In this example, virtual backup appliance 207 is implemented as a specialized VM that is located on the same host computer as the VM that it is responsible for backing up. Alternatively, the virtual backup appliance 207 can be a VM located on a different host computer on the same network. It is also envisioned that virtual backup appliance 207 could be implemented as a separate physical machine on the same network. Furthermore, production data storage 211 and backup data storage 221 can be located on two different physical storage devices or on the same physical storage device. Examples of physical storage devices include hard disk drives and flash memory. In FIG. 2, the one or more physical storage devices used for production data storage 211 and backup data storage 221 are located in storage array 210, which communicates with host 201 through storage area network (SAN) 220. However, this is a non-limiting example and the one or more physical storage devices used for production data storage 211 and backup data storage 221 could be located on host computer 201 or any other device with computer networking capabilities.

In Hyper-V, the hypervisor has a root partition running a Windows Server or Hyper-V Server. This is shown as root partition 204 in FIG. 2. The virtualization stack runs in root partition 204 and has direct access to the hardware devices in host computer 201. Root partition 204 can create child partitions, which is what target VM 203 and virtual backup appliance 207 are, using the hypercall application programming interface (API). Service code 205 is installed on root partition 204 in order to provide an easily consumable interface for virtual backup appliance 207 that coordinates and manages all Hyper-V-specific functionality. Service code 205 is analogous to the web services APIs provided by VMware and XenServer and enables virtual backup appliance 207 to be abstracted from the hypervisor-specific implementation details of creating snapshots or differencing disks and attaching or detaching virtual disks. In one embodiment, RabbitMQ—an advanced message queuing protocol (AMQP) server—is used for communications between virtual backup appliance 207 and service code 205. In other embodiments, any kind of AMPQ or hypertext transfer protocol (HTTP) server could be used for these communications. Hypervisor management 206 refers collectively to the management services provided for the Hyper-V virtualization environment such as the Virtual Machine Management Service (VMMS) and the set of Windows Management Instrumentation (WMI)-based APIs for managing and controlling virtual machines.

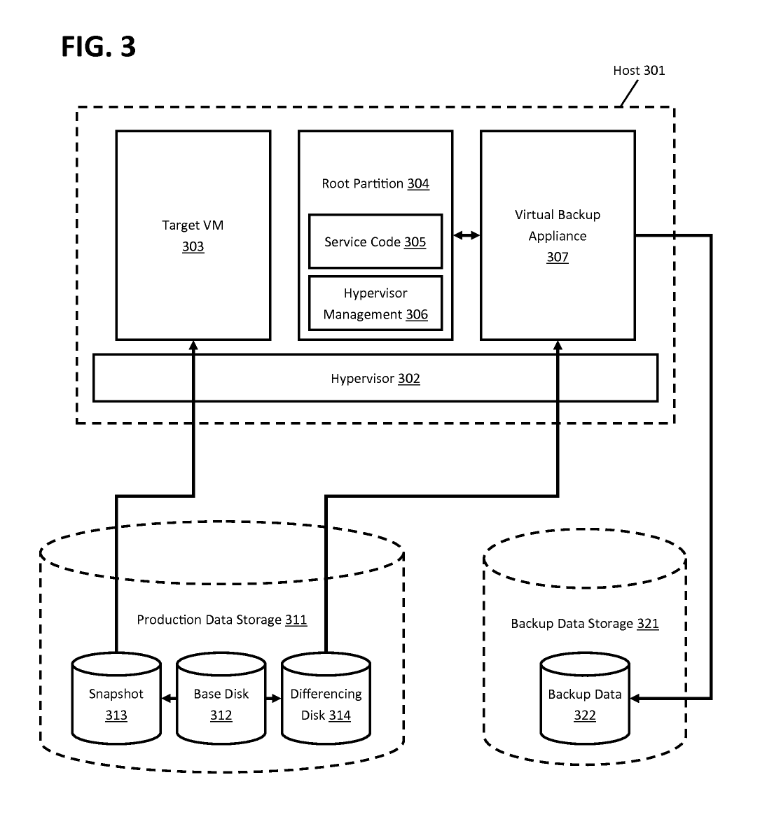

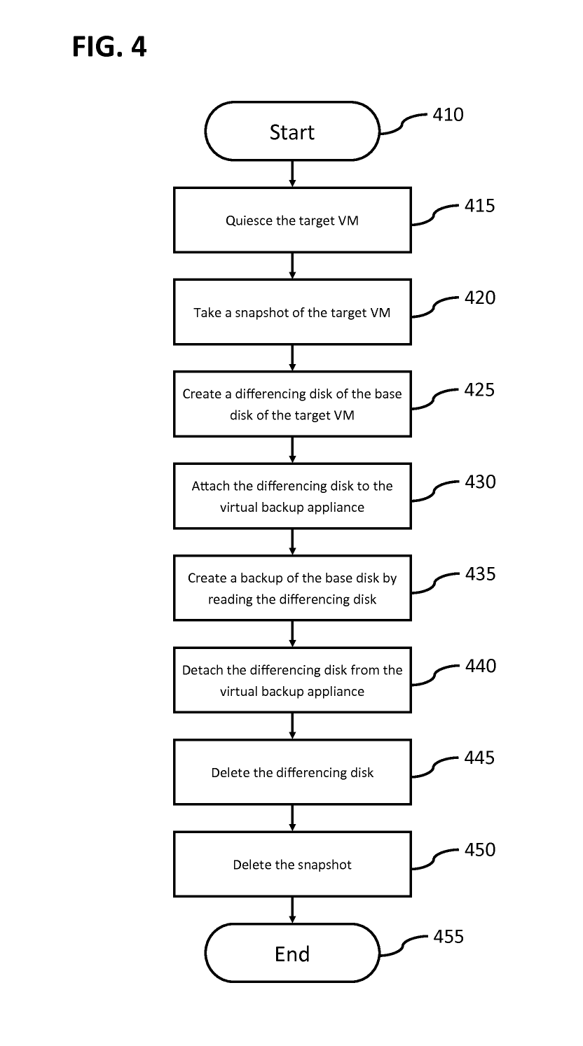

FIG. 4 is a flowchart illustrating a method for backing up a live virtual machine and will be described with reference to FIG. 3, which is a block diagram of a backup system during the backup procedure illustrated by the flowchart of FIG. 4. All of the steps described below, except for step 435, are performed by service code 305 after receiving a request from virtual backup appliance 307. The process begins with step 410.

In step 415, since target VM 303 is running, it may (optionally) be quiesced. If host computer 301 is using Hyper-V as the virtualization platform, target VM 303 should be running a supported operating system and have the latest Hyper-V Guest Integration Services running. In one embodiment, step 415 is accomplished by using the Volume Shadow Copy Service provided by Microsoft.

In step 420, hypervisor 302 is ordered to take a snapshot of target VM 303. This process creates a new file, snapshot 313, to which subsequent disk changes made during the normal operation of target VM 303 are saved. In Hyper-V, snapshot 313 has a .avhd or .avhdx file extension, and base disk 312 is read-only and cannot be attached to another VM because snapshot 313 is associated with base disk 312 and attached to target VM 303. This limitation is enforced by the Hyper-V hypervisor.

In steps 425 and 430, hypervisor 302 is ordered to create differencing disk 314 on base disk 312 and attach the differencing disk to virtual backup appliance 307. In Hyper-V, differencing disk 314 has a .vhd or .vhdx file extension and may be attached to any VM. A differencing disk can be used to capture writes in order to leave the underlying base disk untouched, but here it is being used to view the underlying base disk.

In step 435, virtual backup appliance 307 reads the content of base disk 312 as presented using differencing disk 314 and creates backup data 322. Backup data 322 can be implemented as an exact copy of base disk 312 that is optionally compressed, deduplicated, or encrypted. In another embodiment, the content of base disk 312 is broken down into fixed-length blocks of data that are optionally compressed, given a file name that corresponds to the hash of the fixed-length block of data, and stored in a unique directory structure consisting of 256 first level directories designated as 00-FF, each having 256 second level directories designated as 00-FF within, comprising 65,536 directories in total. Further details regarding a backup data format of this type are provided in U.S. patent application Ser. No. 12/758,245, entitled “VIRTUAL MACHINE DATA BACKUP”, which is incorporated herein by reference.

The remaining steps are essentially cleanup steps. In step 440, once virtual backup appliance 307 is done reading the content of base disk 312 as presented using differencing disk 314, differencing disk 314 is detached from virtual backup appliance 307. In step 445, differencing disk 314 is deleted by service code 305. In Hyper-V, this cannot be accomplished using the management tools. In step 450, snapshot 313 is deleted. In Hyper-V, this can be accomplished using the management tools. Deleting a snapshot involves reading the changes captured in the snapshot file and merging them with the underlying base disk. This merging process occurs without stopping or pausing the running VM. The backup process is completed at step 455.

From the foregoing and with reference to the various figure drawings, those skilled in the art will appreciate that certain modifications can also be made to the present disclosure without departing from the scope of the same. While several embodiments of the disclosure have been shown in the drawings, it is not intended that the disclosure be limited thereto, as it is intended that the disclosure be as broad in scope as the art will allow and that the specification be read likewise. Therefore, the above description should not be construed as limiting, but merely as exemplifications of particular embodiments. Those skilled in the art will envision other modifications within the scope and spirit of the claims appended hereto.

What is claimed is:

1. A system comprising:
a backup data storage area;
a production data storage area storing at least one virtual disk file;
a backup appliance that manages the creation of backup files in the backup data storage area for the at least one virtual disk file; and
a host computer running a hypervisor, wherein the hypervisor manages a root partition and at least one virtual machine, wherein the at least one virtual machine is associated with the at least one virtual disk file, and wherein the root partition has a set of instructions executable on a processor for interpreting backup commands sent from the backup appliance and causing the host computer to:
take a snapshot of the at least one virtual disk file to obtain a snapshot file and a base disk file;
create a differencing disk file from the base disk file; and
create a backup file by reading the content presented by the differencing disk file and storing data that correlates to the content of the base disk file.

2. The system of claim 1, wherein the root partition further includes instructions that cause the host computer to convert generic backup commands sent from the backup appliance into specific commands recognized by the hypervisor running on the host computer.

3. The system of claim 1, wherein the production data storage area and the backup data storage area are located in a storage array.

4. The system of claim 1, wherein the backup appliance is a specialized virtual machine.

5. The system of claim 4, wherein the backup appliance is a child partition on the host computer.

6. The system of claim 1, wherein RabbitMQ is used for communications between the backup appliance and the root partition.

7. The system of claim 1, wherein the host computer uses Microsoft's Hyper-V virtualization platform.

8. The system of claim 1, wherein the root partition further includes instructions that cause the host computer to quiesce the at least one virtual machine.

9. The system of claim 1, wherein the root partition further includes instructions that cause the host computer to compress the data in the backup file that correlates to the content presented by the differencing disk file.

10. The system of claim 1, wherein the root partition further includes instructions that cause the host computer to organize the data that correlates to the content presented by the differencing disk file into multiple fixed-length blocks of data such that each fixed-length block of data has a file name corresponding to the hash of that fixed-length block of data.

11. A method for backing up a virtual machine while it is in operation, comprising:
taking a snapshot of a virtual disk file of the virtual machine to obtain a snapshot file and a base disk file;
creating a differencing disk file from the base disk file;
creating a backup file by reading the content presented by the differencing disk file and storing data that correlates to the content of the base disk file;
deleting the differencing disk file; and
saving changes made to the virtual machine during performance of the preceding steps by merging the changes captured in the snapshot file with the base disk file and deleting the snapshot file.

12. The method of claim 11, wherein at least one step is performed at least in part by a root partition on Microsoft's Hyper-V virtualization platform.

13. The method of claim 11 further comprising quiescing the virtual machine before a snapshot is taken of the virtual machine's virtual disk file.

14. The method of claim 11, further comprising compressing the data in the backup file that correlates to the content presented by the differencing disk file.

15. The method of claim 11, further comprising organizing the data that correlates to the content presented by the differencing disk file into multiple fixed-length blocks of data such that each fixed-length block of data has a file name corresponding to the hash of that fixed-length block of data.

16. A non-transitory machine-readable medium storing a set of instructions that, when executed by a processor, perform a method for backing up a virtual machine while it is in operation, the method comprising:
taking a snapshot of the virtual machine's virtual disk file to obtain a snapshot file and a base disk file;
creating a differencing disk file from the base disk file;
creating a backup file by reading the content presented by the differencing disk file and storing data that correlates to the content of the base disk file;
deleting the differencing disk file; and
saving changes made to the virtual machine during performance of the preceding steps by merging the changes captured in the snapshot file with the base disk file and deleting the snapshot file.

17. The non-transitory machine-readable medium of claim 16, wherein at least one step in the set of instructions configured to perform a method of data backup is performed at least in part on Microsoft's Hyper-V virtualization platform.
